(19) United States
(12) Patent Application Publication
(10) Pub. No.: US 2017/0180467 A1
(43) Pub. Date: Jun. 22, 2017

(54) Method, Device and System for Data Processing based on P2P Network

(71) Applicants: Le Holdings (Beijing) Co., Ltd., Beijing (CN); LeCloud Computing Co., Ltd., Beijing (CN)

(72) Inventor: Zhuo Li, Beijing (CN)

(21) Appl. No.: 15/246,568

(22) Filed: Aug. 25, 2016

Related U.S. Application Data
(63) Continuation of application No. PCT/CN2016/089464, filed on Jul. 8, 2016.

(30) Foreign Application Priority Data
Dec. 21, 2015 (CN) 201510969745.3

(51) Int. Cl. H04L 29/08; H04L 12/26

(52) U.S. Cl. CPC H04L 67/104; H04L 67/1095; H04L 43/16

(57) ABSTRACT

Disclosed are a method, an electronic device and a system for processing data based on a P2P network. The method includes: first of all, receiving, by a P2P server, node information of a nonlicet P2P node sent by a P2P node, wherein the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then performing statistical calculation on report numbers of times respectively corresponding to nonlicet P2P nodes according to the node information of the nonlicet P2P node; finally detecting whether a nonlicet P2P node whose report number of times is greater than or equal to a preset threshold is present; and eliminating the nonlicet P2P node whose report number of times is greater than or equal to the preset threshold from the P2P network if the nonlicet P2P node is present.

### CROSS REFERENCE TO RELATED APPLICATIONS

This application is a continuation of International Application No. PCT/CN2016/089464, filed on Jul. 8, 2016, which is based upon and claims priority to Chinese Patent Application No. 201510969745.3, filed on Dec. 21, 2015, the entire contents of all of which are incorporated herein by reference.

### TECHNICAL FIELD

The present disclosure relates to information technologies, and more particularly, to a method, an electronic device and a system for processing data based on a P2P network.

### BACKGROUND

In recent years, with constant development of information technologies, a P2P technology is widely used, where P2P is short for peer-to-peer, also referred to as “point-to-point”. As an emerging network technology, the “P2P” technology is mainly dependent on computing power of network participants and bandwidth instead of focusing all dependences on a relatively expensive server. P2P is also short for point-to-point. In other words, when a P2P node is downloaded, the P2P node is also uploaded to other nodes on the network. The more the users participating in a P2P network are, correspondingly the more the uploaders are, and the smaller the chance for acquiring data by a P2P terminal from a server is. Therefore, the presence of P2P not only greatly reduces stress of the server, but also achieves an effect that the more the number of people is, the faster the speed is.

At present, during data interaction between nodes in the P2P network, sometimes after one P2P node acquires node information of the other P2P node, the P2P node may establish a malicious link with the other P2P node and send false data to the other P2P node; or incomplete data interaction may be caused by network delay or the like, thereby further causing that one node mistakes data sent by the other node for false data. Either way above may occupy P2P node connection resources, thereby having a negative effect on an efficiency in sharing the P2P network.

### SUMMARY

The present disclosure provides a method, an electronic device and a system for processing data based on a P2P network to solve a problem that at present an efficiency in sharing a P2P network may be affected due to presence of a P2P node maliciously sending false data and a network delay, etc.

Aiming at the problem in the prior art, in a first aspect, embodiments of the present disclosure provide a method for processing data based on a P2P network, implemented by a P2P server, including:

receiving, by a P2P server, node information of a nonlicet P2P node sent by a P2P node, wherein the node information of the nonlicet P2P node is sent by the P2P node when a presence of the nonlicet P2P node is detected, and the nonlicet P2P node is a P2P node that sends false data, whose accumulative number is greater than or equal to a preset number threshold, to the P2P node;

performing statistical calculation on report numbers of times respectively corresponding to nonlicet P2P nodes according to the node information of the nonlicet P2P node;

detecting whether a nonlicet P2P node whose report number of times is greater than or equal to a preset threshold is present; and

eliminating the nonlicet P2P node whose report number of times is greater than or equal to the preset threshold from the P2P network if the nonlicet P2P node is present.

In a second aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for processing data based on a P2P network mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to :

detect, when determining received data sent by a P2P node to be false data, whether a number of the received false data accumulatively sent by the P2P node is greater than or equal to a preset number threshold;

determine the P2P node to be a nonlicet P2P node if the number of the false data is greater than or equal to the preset number threshold;

disconnect from the nonlicet P2P node and record node information of the nonlicet P2P node so as not to connect with the nonlicet P2P node when a connection request sent by the nonlicet P2P node is received again; and

send the node information of the nonlicet P2P node to a P2P server, wherein the P2P server receives the node information of the nonlicet P2P node sent by a P2P node so that the P2P server performs statistical calculation on report numbers of times respectively corresponding to the nonlicet P2P nodes according to the node information of the nonlicet P2P node and carries out a detection, and eliminates a nonlicet P2P node whose report number of times is greater than or equal to a preset threshold from the P2P network if the nonlicet P2P node is present upon detection.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram of a method for processing data based on a P2P network in accordance with some embodiments;

FIG. 2 is a schematic flow diagram of another method for processing data based on a P2P network in accordance with some embodiments;

FIG. 3 is a schematic flow diagram of still another method for processing data based on a P2P network in accordance with some embodiments;

FIG. 4 is a schematic structural diagram of a P2P server in accordance with some embodiments;

FIG. 5 is a schematic structural diagram of another P2P server in accordance with some embodiments;

FIG. 6 is a schematic structural diagram of a P2P node in accordance with some embodiments;

FIG. 7 is a schematic structural diagram of another P2P node in accordance with some embodiments;

FIG. 8 is a schematic structural diagram of a system for processing data based on a P2P network in accordance with some embodiments;

FIG. 9 is a schematic diagram of an entity structure of a P2P server in accordance with some embodiments; and

FIG. 10 is a block diagram of an electronic device which is configured to perform the methods for processing data based on a P2P network in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

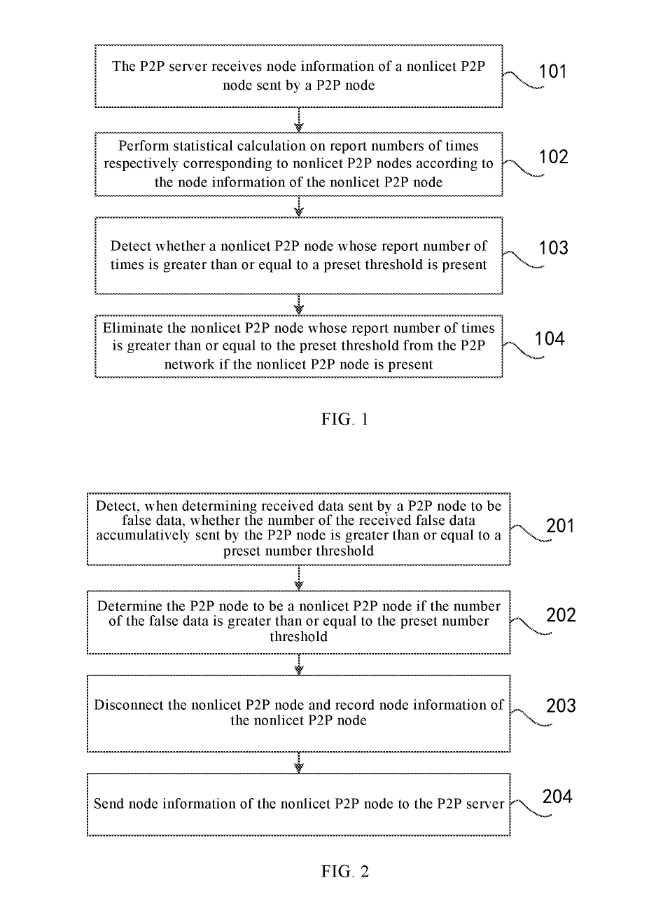

Embodiments of the present disclosure provide a method for processing data based on a P2P network, which can be applied to a P2P server, as shown in FIG. 1, the method includes following steps.

101: The P2P server receives node information of a nonlicet P2P node sent by a P2P node.

The node information of the nonlicet P2P node is sent by the P2P node when presence of the nonlicet P2P node is detected, where the node information may include a node name, an identity (ID) number, etc. The nonlicet P2P node is a P2P node that sends false data, whose accumulative number is greater than or equal to a preset number threshold, to the P2P node. The preset number threshold can be configured according to actual demands.

102: Statistical calculation is performed on report numbers of times respectively corresponding to nonlicet P2P nodes according to the node information of the nonlicet P2P node.

For example, when receiving node information of a nonlicet P2P node sent by a P2P node, the P2P server can determine the nonlicet P2P node to be a No. 4 P2P node in the current P2P network according to the node information of the nonlicet P2P node, accumulatively adds 1 to the report number of times corresponding to the No. 4 P2P node, and finally can obtain by statistics report numbers of times respectively corresponding to different nonlicet P2P nodes in the current P2P network by using the same way.

103: It is detected whether a nonlicet P2P node whose report number of times is greater than or equal to a preset threshold is present.

The preset threshold can be configured according to actual demands or can be configured by a system by default, which is not limited in the embodiments of the present disclosure.

104: The nonlicet P2P node whose report number of times is greater than or equal to the preset threshold is eliminated from the P2P network if the nonlicet P2P node is present.

To the embodiments of the present disclosure, by eliminating a nonlicet P2P node whose report number of times is greater than or equal to the preset threshold from the P2P network, some P2P nodes maliciously sending false data and some P2P nodes having poor upload speeds can be eliminated from the P2P network, thereby achieving an objective of purifying P2P network environment.

Further, after executing Step 104, the method may further include: outputting prompt information, where the prompt information is used for prompting that the nonlicet node whose report number of times is greater than or equal to the preset threshold has been eliminated from the P2P network. The prompt information may be text prompt information, image prompt information, audio prompt information or video prompt information and so on. It is to be noted that after executing Step 104, by outputting prompt information, it is clear for P2P network maintenance personnel that some nonlicet nodes whose report numbers of times are greater than or equal to the preset threshold have been eliminated from the P2P network. In this way, user experience can be improved.

According to a method for processing data based on a P2P network provided by embodiments of the present disclosure, first of all, a P2P server receives node information of a nonlicet P2P node sent by a P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then statistical calculation is performed on report numbers of times respectively corresponding to nonlicet P2P nodes by means of the P2P server; and finally a nonlicet P2P node whose report number of times is greater than or equal to the preset threshold is eliminated from the P2P network. In this way, some P2P nodes maliciously sending false data and some P2P nodes having poor upload speeds can be eliminated from the P2P network, and an objective of purifying P2P network environment can be achieved, thereby improving an efficiency in sharing the P2P network.

Embodiments of the present disclosure provide another method for processing data based on a P2P network, which can be applied to a P2P node, as shown in FIG. 2, the method includes following steps.

201: It is detected, when determining received data sent by a P2P node to be false data, whether the number of the received false data accumulatively sent by the P2P node is greater than or equal to a preset number threshold.

The false data can be data not matched with data required to be acquired, or can be data where data is incomplete or lost. The preset number threshold can be configured according to actual demands and used for verifying whether a P2P node is a nonlicet P2P node.

202: The P2P node is determined to be a nonlicet P2P node if the number of the false data is greater than or equal to the preset number threshold.

203: The nonlicet P2P node is disconnected and node information of the nonlicet P2P node is recorded.

Further, when a connection request sent by the nonlicet P2P node is received again, the nonlicet P2P node is not connected, thereby avoiding occupying other node connection resources. The node information can be a node name or an ID number, etc.

204: Node information of the nonlicet P2P node is sent to the P2P server.

The P2P server receives node information of different nonlicet P2P nodes sent by different P2P nodes so that the P2P server performs statistical calculation on report numbers of times respectively corresponding to the different nonlicet P2P nodes according to the node information of the different nonlicet P2P nodes and carries out a detection, and eliminates a nonlicet P2P node whose report number of times is greater than or equal to a preset threshold from the P2P network if the nonlicet P2P node is present upon detection. In this way, the objective of purifying P2P network environment can be achieved, and the efficiency in sharing the P2P network can be improved.

According to another method for processing data based on a P2P network provided by embodiments of the present disclosure, first of all, a P2P server receives node information of a nonlicet P2P node sent by a P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then statistical calculation is performed on report numbers of times respectively corresponding to nonlicet P2P nodes by means of the P2P server; and finally a nonlicet P2P node whose report number of times is greater than or equal to the preset threshold is eliminated from the P2P network. In this way, some P2P nodes maliciously sending false data and some P2P nodes having poor upload speeds can be eliminated from the P2P network, and an objective of purifying P2P network environment can be achieved, thereby improving an efficiency in sharing the P2P network.

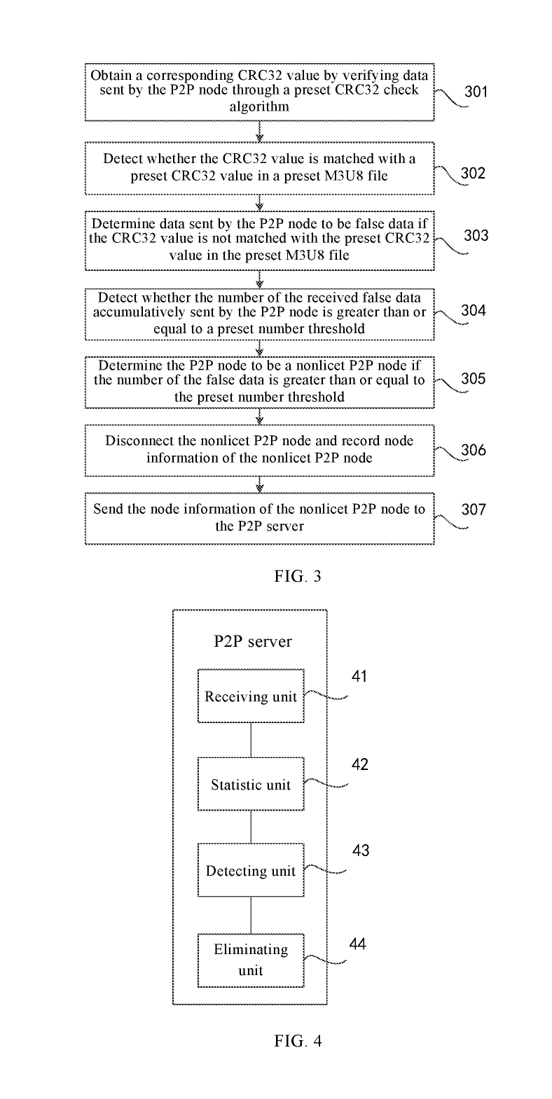

Embodiments of the present disclosure provide still another method for processing data based on a P2P network, which can be applied to a P2P node, as shown in FIG. 3, the method includes following steps.

301: A corresponding CRC32 value is obtained by verifying data sent by the P2P node through a preset CRC32 check algorithm.

302: It is detected whether the CRC32 value is matched with a preset CRC32 value in a preset M3U8 file.

The preset M3U8 file can be an M3U file having a UTF-8 coded format. The preset CRC32 value can be a CRC32 value corresponding to data required to be acquired locally. Specifically, the preset CRC32 value can be saved in the preset M3U8 file in advance so that the preset CRC32 value can be invoked when it is required to verify false data.

303: Data sent by the P2P node are determined to be false data if the CRC32 value is not matched with the preset CRC32 value in the preset M3U8 file.

304: It is detected whether the number of the received false data accumulatively sent by the P2P node is greater than or equal to a preset number threshold.

The false data can be data where data is incomplete or lost, or data not matched with data required to be acquired. The preset number threshold can be configured according to actual demands.

305: The P2P node is determined to be a nonlicet P2P node if the number of the false data is greater than or equal to the preset number threshold.

Further, after executing the Step 305, the method may further include: outputting prompt information, where the prompt information is used for prompting that the P2P node is a nonlicet P2P node. The prompt information can be text prompt information, image prompt information, audio prompt information or video prompt information and so on. It is to be noted that after executing Step 305, by outputting prompt information, a user can know that a nonlicet P2P node is present, which is convenient for post processing for the user and can enhance the user experience.

306: The nonlicet P2P node is disconnected and node information of the nonlicet P2P node is recorded.

Further, when a connection request sent by the nonlicet P2P node is received again, the nonlicet P2P node is not connected, thereby avoiding occupying other node connection resources.

307: Node information of the nonlicet P2P node is sent to the P2P server.

The P2P server receives node information of different nonlicet P2P nodes sent by different P2P nodes. Further, the P2P server is caused to perform statistical calculation on report numbers of times respectively corresponding to the different nonlicet P2P nodes according to the node information of the different nonlicet P2P nodes and carries out a detection, and eliminates a nonlicet P2P node whose report number of times is greater than or equal to a preset threshold from the P2P network if the nonlicet P2P node is present upon detection. In this way, the objective of purifying P2P network environment can be achieved, and the efficiency in sharing the P2P network can be improved.

According to still another method for processing data based on a P2P network provided by embodiments of the present disclosure, first of all, a P2P server receives node information of a nonlicet P2P node sent by a P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then statistical calculation is performed on report numbers of times respectively corresponding to nonlicet P2P nodes by means of the P2P server; and finally a nonlicet P2P node whose report number of times is greater than or equal to the preset threshold is eliminated from the P2P network. In this way, some P2P nodes maliciously sending false data and some P2P nodes having poor upload speeds can be eliminated from the P2P network, and an objective of purifying P2P network environment can be achieved, thereby improving an efficiency in sharing the P2P network.

Further, as a concrete implementation of the method as shown in FIG. 1, embodiments of the present disclosure provide a P2P server, as shown in FIG. 4, the P2P server includes: a receiving unit 41, a statistic unit 42, a detecting unit 43 and an eliminating unit 44.

The receiving unit 41 can be configured to receive node information of a nonlicet P2P node sent by a P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node. The receiving unit 41 faces to each P2P node.

The statistic unit 42 can be configured to perform statistical calculation on report numbers of times respectively corresponding to nonlicet P2P nodes according to the node information of the nonlicet P2P node received by the receiving unit 41. The statistic unit 42 is a main functional module, in the P2P server, for performing statistical calculation on report number of times corresponding to a nonlicet P2P node.

The detecting unit 43 can be configured to detect whether a nonlicet P2P node whose report number of times is greater than or equal to a preset threshold is present. The detecting unit 43 is a main functional module, in the P2P server, for detecting whether a nonlicet P2P node whose report number of times is greater than or equal to a preset threshold is present.

The eliminating unit 44 can be configured to eliminate a nonlicet P2P node whose report number of times is greater than or equal to the preset threshold from the P2P network if the detecting unit 43 detects that the nonlicet P2P node whose report number of times is greater than or equal to the preset threshold is present. The eliminating unit 44 is a main functional module, in the P2P server, for eliminating a nonlicet P2P node whose report number of times is greater than or equal to the preset threshold from the P2P network so as to achieve an objective of purifying P2P network environment.

It is to be noted that reference can be made to corresponding description in FIG. 1 for other corresponding description of various functional units involved with a P2P server provided by embodiments of the present disclosure, which is not unnecessarily elaborated any more herein. In the embodiments of the present disclosure, relevant functional modules can be implemented by means of a hardware processor.

According to a P2P server provided by embodiments of the present disclosure, first of all, the P2P server receives node information of a nonlicet P2P node sent by a P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then statistical calculation is performed on report numbers of times respectively corresponding to nonlicet P2P nodes by means of the P2P server; and finally a nonlicet P2P node whose report number of times is greater than or equal to the preset threshold is eliminated from the P2P network. In this way, some P2P nodes maliciously sending false data and some P2P nodes having poor upload speeds can be eliminated from the P2P network, and an objective of purifying P2P network environment can be achieved, thereby improving an efficiency in sharing the P2P network.

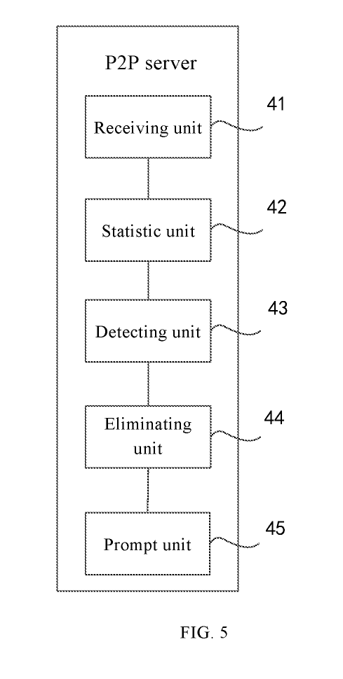

Specifically, embodiments of the present disclosure provide another P2P server, as shown in FIG. 5, the P2P server further includes: an outputting unit 45.

The outputting unit 45 can be configured to output prompt information, where the prompt information is used for prompting that the nonlicet node whose report number of times is greater than or equal to the preset threshold has been eliminated from the P2P network.

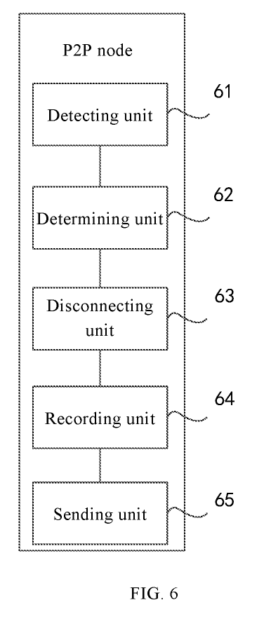

Further, as a concrete implementation of the method as shown in FIG. 2, embodiments of the present disclosure provide a P2P node, as shown in FIG. 6, the P2P node includes: a detecting unit 61, a determining unit 62, a disconnecting unit 63, a recording unit 64 and a sending unit 65.

The detecting unit 61 can be configured to detect, when determining received data sent by a P2P node to be false data, whether a number of the received false data accumulatively sent by the P2P node is greater than or equal to a preset number threshold. The detecting unit 61 is a main functional module, in the P2P server, for detecting whether a nonlicet P2P node is present.

The determining unit 62 can be configured to determine the P2P node to be a nonlicet P2P node if the detecting unit 61 detects that the number of the false data is greater than or equal to the preset number threshold.

The disconnecting unit 63 can be configured to disconnect from the nonlicet P2P node. The disconnecting unit 63 is a main functional module for controlling connection between the P2P node and the nonlicet P2P node.

The recording unit 64 can be configured to record node information of the nonlicet P2P node. The recording unit 64 is a main functional module, in the P2P node, for recording node information of a nonlicet P2P node.

Further, when a connection request sent by the nonlicet P2P node is received again, the nonlicet P2P node is not connected.

The sending unit 65 can be configured to send the node information of the nonlicet P2P node to the P2P server, and the P2P server receives the node information of the nonlicet P2P node sent by a P2P node. The sending unit 65 faces to the P2P server.

Further, the P2P server is caused to perform statistical calculation on report numbers of times respectively corresponding to nonlicet P2P nodes according to the node information of the nonlicet P2P node and carries out a detection, and eliminate a nonlicet P2P node whose report number of times is greater than or equal to a preset threshold from the P2P network if the nonlicet P2P node is present upon detection.

It is to be noted that reference can be made to corresponding description in FIG. 2 for other corresponding description of various functional units involved with a P2P node provided by embodiments of the present disclosure, which is not unnecessarily elaborated any more herein. In the embodiments of the present disclosure, relevant functional modules can be implemented by means of a hardware processor.

According to a P2P node provided by embodiments of the present disclosure, first of all, a P2P server receives node information of a nonlicet P2P node sent by the P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then statistical calculation is performed on report numbers of times respectively corresponding to nonlicet P2P nodes by means of the P2P server; and finally a nonlicet P2P node whose report number of times is greater than or equal to the preset threshold is eliminated from the P2P network. In this way, some P2P nodes maliciously sending false data and some P2P nodes having poor upload speeds can be eliminated from the P2P network, and an objective of purifying P2P network environment can be achieved, thereby improving an efficiency in sharing the P2P network.

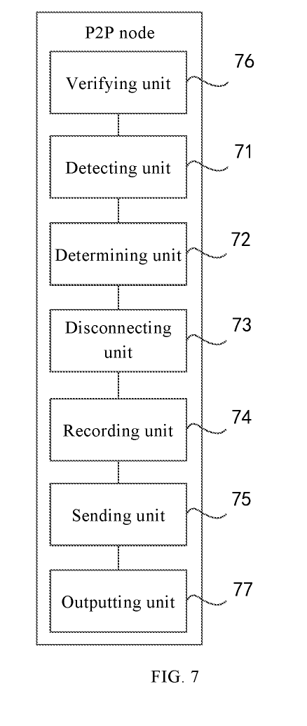

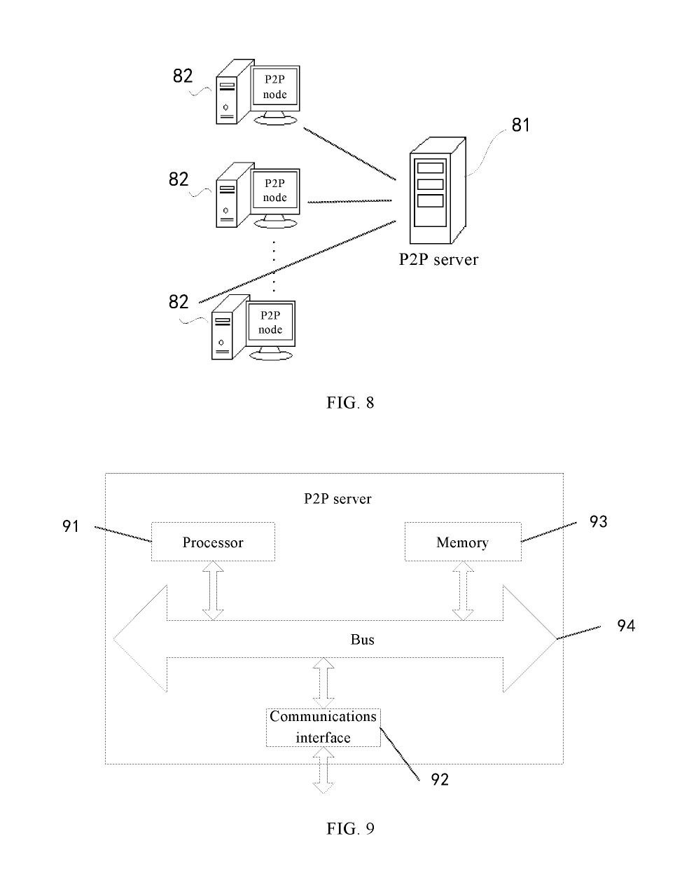

Further, as a concrete implementation of the method as shown in FIG. 3, embodiments of the present disclosure provide another P2P node, as shown in FIG. 7, the P2P node includes: a detecting unit 71, a determining unit 72, a disconnecting unit 73, a recording unit 74 and a sending unit 75.

The detecting unit 71 can be configured to detect, when determining received data sent by a P2P node to be false data, whether a number of the received false data accumulatively sent by the P2P node is greater than or equal to a preset number threshold. The detecting unit 71 is a main functional module, in the P2P server, for detecting whether a nonlicet P2P node is present.

The determining unit 72 can be configured to determine the P2P node to be a nonlicet P2P node if the detecting unit 71 detects that the number of the false data is greater than or equal to the preset number threshold.

The disconnecting unit 73 can be configured to disconnect from the nonlicet P2P node. The disconnecting unit 73 is a main functional module for controlling connection between the P2P node and the nonlicet P2P node.

The recording unit 74 can be configured to record node information of the nonlicet P2P node. The recording unit 74 is a main functional module, in the P2P node, for recording node information of a nonlicet P2P node.

Further, when a connection request sent by the nonlicet P2P node is received again, the nonlicet P2P node is not connected.

The sending unit 75 can be configured to send the node information of the nonlicet P2P node to the P2P server, and the P2P server receives the node information of the nonlicet P2P node sent by a P2P node. The sending unit 75 faces to the P2P server.

Further, the P2P server is caused to perform statistical calculation on report numbers of times respectively corresponding to the nonlicet P2P nodes according to the node information of the nonlicet P2P nodes and carries out a detection, and eliminate a nonlicet P2P node whose report number of times is greater than or equal to a preset threshold from the P2P network if the nonlicet P2P node is present upon detection.

Further, the P2P node also includes: a verifying unit 76.

The verifying unit 76 can be configured to verify data sent by the P2P node through a preset CRC32 check algorithm to obtain a corresponding CRC32 value.

The detecting unit 71 further can be configured to detect whether the CRC32 value is matched with a preset CRC32 value in a preset M3U8 file.

The determining unit 72 further can be configured to determine the data sent by the P2P node to be false data if the detecting unit 71 detects that the CRC32 value is not matched with the preset CRC32 value in the preset M3U8 file.

Further, the P2P node also includes: an output unit 77.

The outputting unit 77 can be configured to output prompt information, where the prompt information is used for prompting that the P2P node is a nonlicet P2P node.

It is to be noted that reference can be made to corresponding description in FIG. 3 for other corresponding description of various functional units involved with another P2P node provided by the embodiments of the present disclosure, which is not unnecessarily elaborated any more herein. In the embodiments of the present disclosure, relevant functional modules can be implemented by means of a hardware processor.

According to another P2P node provided by embodiments of the present disclosure, first of all, a P2P server receives node information of a nonlicet P2P node sent by the P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then statistical calculation is performed on report numbers of times respectively corresponding to nonlicet P2P nodes by means of the P2P server; and finally a nonlicet P2P node whose report number of times is greater than or equal to the preset threshold is eliminated from the P2P network. In this way, some P2P nodes maliciously sending false data and some P2P nodes having poorer upload speeds can be eliminated from the P2P network, and an objective of purifying P2P network environment can be achieved, thereby improving an efficiency in sharing the P2P network.

Further, embodiments of the present disclosure provide a system for processing data based on a P2P network, including: a P2P server 81 and a P2P node 82.

The P2P node 82 can be configured to: detect, when determining received data sent by the P2P node to be false data, whether the number of received false data accumulatively sent by the P2P node is greater than or equal to a preset number threshold; determine the P2P node to be a nonlicet P2P node if the number of the false data is greater than or equal to the preset number threshold; disconnect from the nonlicet P2P node and record node information of the nonlicet P2P node so as not to connect with the nonlicet P2P node when a connection request sent by the nonlicet P2P node is received again; and send the node information of the nonlicet P2P node to the P2P server 81.

The P2P server 81 is configured to: receive node information of different nonlicet P2P nodes sent by different P2P nodes 81; perform statistical calculation on report numbers of times respectively corresponding to the different nonlicet P2P nodes according to the node information of the different nonlicet P2P nodes; detect whether a nonlicet P2P node whose report number of times is greater than or equal to a preset threshold is present; and eliminate the nonlicet P2P node whose report number of times is greater than or equal to the preset threshold from the P2P network if the nonlicet P2P node is present.

Exemplarily, as shown in FIG. 9, which illustrates a schematic diagram of an entity structure of a P2P server according to embodiments of the present disclosure, the P2P server can include: a processor 91, a communications interface 92, a memory 93 and a bus 94, where the processor 91, the communications interface 92 and the memory 93 complete communications among each other through the bus 94. The communications interface 92 can be configured to implement information transmission between the server and a client. The processor 91 can invoke a logic instruction in the memory 93 to perform the following method: a P2P server receives node information of a nonlicet P2P node sent by a P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; statistical calculation is performed on report numbers of times respectively corresponding to nonlicet P2P nodes according to the node information of the nonlicet P2P nodes; it is detected whether a nonlicet P2P node whose report number of times is greater than or equal to a preset threshold is present; and the nonlicet P2P node whose report number of times is greater than or equal to the preset threshold is eliminated from the P2P network if the nonlicet P2P node is present. In addition, when a logic instruction in the foregoing memory 93 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

According to the system for processing data based on a P2P network provided by embodiments of the present disclosure, first of all, a P2P server receives node information of a nonlicet P2P node sent by the P2P node, where the node information of the nonlicet P2P node is sent by the P2P node when a presence of the nonlicet P2P node is detected, the nonlicet P2P node is a P2P node that sends false data, whose accumulative number is greater than or equal to a preset number threshold, to the P2P node; then statistical calculation is performed on report numbers of times respectively corresponding to nonlicet P2P nodes by means of the P2P server; and finally a nonlicet P2P node whose report number of times is greater than or equal to the preset threshold is eliminated from the P2P network. In this way, some P2P nodes maliciously sending false data and some P2P nodes having poorer upload speeds can be eliminated from the P2P network, and an objective of purifying P2P network environment can be achieved, thereby improving an efficiency in sharing the P2P network.

Further, an embodiment of the present disclosure further provides a non-transitory computer-readable storage medium storing executable instructions, which can be executed by an electronic device to perform any methods for processing data based on a P2P network mentioned by embodiments of the present disclosure.

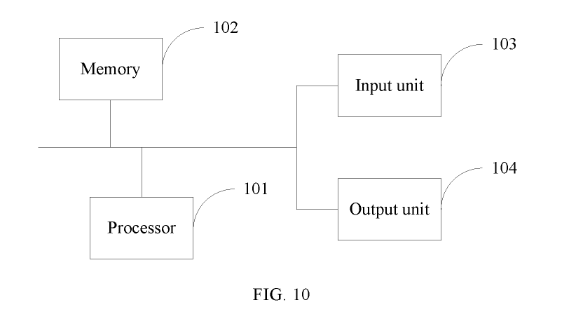

FIG. 10 is a block diagram of an electronic device which is configured to perform the methods for processing data based on a P2P network according to an embodiment of the present disclosure. As shown in FIG. 10, the device includes:

one or more processors 101 and memory 102. A processor 101 is showed in FIG. 10 for an example.

Device which is configured to perform the methods for processing data based on a P2P network can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for processing data based on a P2P network mentioned by embodiments of the present disclosure (such as shown in FIG. 4, receiving unit 41, statistic unit 42, detecting unit 43 and eliminating unit 44). Processor 101 performs kinds of functions and processing data based on a P2P network of the electronic device by executing non-transitory software program, instructions and modules which are stored in memory 102, thereby realizes the methods for processing data based on a P2P network mentioned by embodiments of the present disclosure.

Memory 102 can include program storage area and data storage area, thereby the operating system and applications required by at least one function can be stored in program storage area and data created by using the device for processing data based on a P2P network can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for processing data based on a P2P network by networks. The examples of said networks are including but not limited to Internet, Intranet, LAN, mobile Internet and their combinations.

Input unit 103 can be used to receive inputted number, character information and key signals causing user configures and function controls of the device for processing data based on a P2P network. Output unit 104 can include a display screen or a display device.

The said module or modules are stored in memory 102 and perform the methods for processing data based on a P2P network when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for processing data based on a P2P network, implemented by a P2P server, comprising:
receiving, by a P2P server, node information of a nonlicet P2P node sent by a P2P node, wherein the node information of the nonlicet P2P node is sent by the P2P node when a presence of the nonlicet P2P node is detected, and the nonlicet P2P node is a P2P node that sends false data, whose accumulative number is greater than or equal to a preset number threshold, to the P2P node;
performing statistical calculation on report numbers of times respectively corresponding to nonlicet P2P nodes according to the node information of the nonlicet P2P node;
detecting whether a nonlicet P2P node whose report number of times is greater than or equal to a preset threshold is present; and
eliminating the nonlicet P2P node whose report number of times is greater than or equal to the preset threshold from the P2P network if the nonlicet P2P node is present.

2. The method for processing data based on a P2P network according to claim 1, wherein after the eliminating the nonlicet node whose report number of times is greater than or equal to the preset threshold from the P2P network if the nonlicet P2P node is present, the method further comprises:
outputting prompt information, wherein the prompt information is used for prompting that the nonlicet node whose report number of times is greater than or equal to the preset threshold has been eliminated from the P2P network.

3. An electronic device, comprising:
at least one processor; and
a memory communicably connected with the at least one processor for storing instructions executable by the at least one processor, wherein execution of the instructions by the at least one processor causes the at least one processor to:
receive node information of a nonlicet P2P node sent by a P2P node, wherein the node information of the nonlicet P2P node is sent by the P2P node when a presence of the nonlicet P2P node is detected, and the nonlicet P2P node is a P2P node that sends false data, whose accumulative number is greater than or equal to a preset number threshold, to the P2P node;
perform statistical calculation on report numbers of times respectively corresponding to nonlicet P2P nodes according to the node information of the nonlicet P2P node;
detect whether a nonlicet P2P node whose report number of times is greater than or equal to a preset threshold is present; and
eliminate the nonlicet P2P node whose report number of times is greater than or equal to the preset threshold from the P2P network if the nonlicet P2P node is present.

4. The electronic device according to claim 3, wherein the instructions are executed to cause the at least one processor to:
output prompt information, wherein the prompt information is used for prompting that the nonlicet node whose report number of times is greater than or equal to the preset threshold has been eliminated from the P2P network.

5. An electronic device, comprising:
at least one processor; and
a memory communicably connected with the at least one processor for storing instructions executable by the at least one processor, wherein execution of the instructions by the at least one processor causes the at least one processor to:
detect, when determining received data sent by a P2P node to be false data, whether a number of the received false data accumulatively sent by the P2P node is greater than or equal to a preset number threshold;
determine the P2P node to be a nonlicet P2P node if the number of the false data is greater than or equal to the preset number threshold;
disconnect from the nonlicet P2P node and record node information of the nonlicet P2P node so as not to connect with the nonlicet P2P node when a connection request sent by the nonlicet P2P node is received again; and
send the node information of the nonlicet P2P node to a P2P server, wherein the P2P server receives the node information of the nonlicet P2P node sent by a P2P node so that the P2P server performs statistical calculation on report numbers of times respectively corresponding to the nonlicet P2P nodes according to the node information of the nonlicet P2P node and carries out a detection, and eliminates a nonlicet P2P node whose report number of times is greater than or equal to a preset threshold from the P2P network if the nonlicet P2P node is present upon detection.

6. The electronic device according to claim 5, wherein the instructions are executed to cause the at least one processor to:
verify data sent by the P2P node through a preset CRC32 check algorithm to obtain a corresponding CRC32 value;
detect whether the CRC32 value is matched with a preset CRC32 value in a preset M3U8 file; and
determine the data sent by the P2P node to be false data if the CRC32 value is not matched with the preset CRC32 value.

7. The electronic device according to claim 5, wherein the instructions are executed to cause the at least one processor to:
output prompt information, wherein the prompt information is used for prompting that the P2P node is a nonlicet P2P node.
